(19) United States
(12) Patent Application Publication
(10) Pub. No.: US 2025/0321630 A1
(43) Pub. Date: Oct. 16, 2025

(54) Single-Handed Mode for an Artificial Reality System

(71) Applicant: Meta Platforms Technologies, LLC, Menlo Park, CA (US)

(72) Inventors: Sabrina ZHAI, New York, NY (US); Yuehan WANG, Sunnyvale, CA (US); Divya SREEKUMAR, Seattle, WA (US); Christopher DINH, Carson, CA (US); Debkanya MAZUMDER, Mountain View, CA (US); Hongyu ZHANG, Arcadia, CA (US); Nick NANCE, Norman, OK (US); Jennifer MORROW, Sunnyvale, CA (US); Santiago CERÓN URIBE, Brooklyn, NY (US)

(21) Appl. No.: 18/631,869

(22) Filed: Apr. 10, 2024

(51) Int. Cl. G06F 3/01; G06F 3/0482; G06F 3/04845; G06T 19/00

(52) U.S. Cl. CPC G06F 3/011; G06F 3/017; G06F 3/0482; G06F 3/04845; G06T 19/006

(57) ABSTRACT

Aspects of the present disclosure are directed to operating an artificial reality system in single-handed mode. Artificial reality systems receive user input via several channels, however conventional systems lack functionality that helps diverse users operate these systems. Some types of input, such as input that requires movement of two hands and/or two hand-held controllers, may be more challenging for some diverse individuals to provide or may not be possible in certain situations, e.g., where one controller is disabled. Implementations operate artificial reality systems in single-handed mode, such as by translating instances of single-handed input into two-handed input. For example, the translated two-handed input can cause application functionality at the artificial reality system that would otherwise pose a challenge for some diverse individual.

### TECHNICAL FIELD

The present disclosure is directed to operating an artificial reality system in single-handed mode.

### BACKGROUND

The variety in which users interact with computing systems has grown over time. For example, artificial reality systems can include controller-based interactions, interactions via eye tracking, interactions based on input from movement sensors, among others. Because these techniques create new ways for users to provide input to computing systems, interpreting these inputs has become meaningful. For example, the way a computing system interprets user inputs to implement functions (i.e., perform changes to a display provided to the user) can have a significant impact on user experience.

### BRIEF DESCRIPTION OF THE DRAWINGS

FIG. 1 is a block diagram illustrating an overview of devices on which some implementations of the present technology can operate.

FIG. 2A is a wire diagram illustrating a virtual reality headset which can be used in some implementations of the present technology.

FIG. 2B is a wire diagram illustrating a mixed reality headset which can be used in some implementations of the present technology.

FIG. 2C is a wire diagram illustrating controllers which, in some implementations, a user can hold in one or both hands to interact with an artificial reality environment.

FIG. 3 is a block diagram illustrating an overview of an environment in which some implementations of the present technology can operate.

FIG. 4 is a block diagram illustrating components which, in some implementations, can be used in a system employing the disclosed technology.

FIG. 5A is a conceptual diagram illustrating hand-held controllers used to provide input to an artificial reality system.

FIG. 5B is a conceptual diagram illustrating two hands used to provide input to an artificial reality system.

FIG. 6 is a conceptual diagram illustrating an input translator used to translate single-handed input into two-handed input.

FIG. 7 is a flow diagram illustrating a process used in some implementations of the present technology for operating an artificial reality system in single-handed mode.

The techniques introduced here may be better understood by referring to the following Detailed Description in conjunction with the accompanying drawings, in which like reference numerals indicate identical or functionally similar elements.

### DETAILED DESCRIPTION

Aspects of the present disclosure are directed to operating an artificial reality system in single-handed mode. Artificial reality systems receive user input via several channels, such as hand-held controller input, tracked hand movement, gaze input, voice input, and the like. However, conventional systems lack functionality that helps diverse users operate these systems. For example, application functionality at artificial reality systems is triggered via user input. Some types of input, such as input that requires movement of two hands and/or two hand-held controllers, may be more challenging for some diverse individuals to provide or may not be possible when only one hand or controller is available. Implementations described herein operate artificial reality systems in single-handed mode, such as by translating instances of single-handed input into two-handed input. For example, the translated two-handed input can cause application functionality at the artificial reality system that would otherwise pose a challenge for some users or in some circumstances.

Implementations of an input translator can translate input from a user related to a single hand, such as movement data of a single hand and/or input from a single hand-held controller, into two-handed input. This translation can be performed when the artificial reality system is operating in single-handed mode. For example, single-handed mode can be set by default for some users; set in response to input that triggers the mode; in response to certain circumstances such as lost tracking of one hand or controller, non-movement of a hand or controller for a threshold amount of time, battery depletion of a controller, etc.; or via any other suitable trigger. When operating in single-handed mode, the input translator can translate single-handed user input into two-handed user input by: simulating additional input corresponding to the single-handed user input; predicting, using a trained machine learning model, the two-handed input based on the single-handed user input; combining the single-handed user input and a second user input provided in a mode other than a hand gesture; and/or mapping a first portion of the single-handed user input to first hand input and mapping a second portion of the single-handed user input to second hand input.

In some implementations, the input translator can simulate, using the single-handed user input, additional input. The additional input can be a mirror of the single-handed user input. For example, some hand gestures include two hands performing two parts of a gesture, where the two parts are mirror images of one another, such as a “pulling apart” gesture where two hands start in close proximity in a pinched orientation and move away from each other. The input translator can simulate input that mirrors the single-handed user input from the perspective of a second hand, such as by inverting a direction of detected motion. The simulated input can enable single-handed user input to resemble two-handed input that matches a predefined gestures, such as clapping, pulling apart, or any other suitable two-handed gesture.

In some implementations, the input translator can predict, using a trained machine learning model, two-handed input based on the single-handed user input. For example, machine learning model(s) can be trained using training data that comprises historic instances of two-handed user input, such as instances that correspond to two-handed gestures (e.g., clapping, stretching out two hands, a stop signal via two hands cross-crossing, two-handed dance moves, etc.). An instance of two-handed user input can be processed into a training instance of: single-handed user input (e.g., half of the two-handed use input), and the two-handed user input from which the single-handed user input was derived (e.g., two-handed input that corresponds to a predefined gesture). The training data can train the machine learning model(s) to generate a two-handed input prediction (e.g., input that corresponds to a predefined gesture) that likely corresponds to the single-handed user input provided by a user.

In some implementations, the input translator can combine single-handed user input and a second user input provided in another mode, such as voice input, gaze input, head movement, button-press input at a hand-held controller, and the like. For example, the user can provide voice input associated with the single-handed input, such as language that describes/names a two-handed gesture (e.g., “stop”) while providing single-handed user input (e.g., moving the user's hand to perform part of a two-handed stop motion). In some implementations, predefined mapping(s) can associate certain auxiliary input, such as head movement gaze input, button presses at a hand-held controller, etc., with combination techniques with respect to one-handed user input. For example, holding down a button while moving a hand-held controller may indicate that the user's voice input should be combined with the hand-held controller movement to translate the input into two-handed input. In another example, a predefined head movement (e.g., nodding gesture) may indicate the tracked movement of a single user hand should be provided to trained machine learning model(s) to predict two-handed input based on the single-handed user input.

Machine learning model(s) for this implementation can be trained using training data that is based on historic instances of two-handed user input. For each training instance-input to the model can be a single hand input combined with a label such as a textual description of the resulting two-handed user input, where another model can be used to evaluate the result of the two-handed user input to generate the textual description, and the output for that training instance (to be compared to the model output for updating model parameters in training) can be the actual two-handed user input. Thus, the historic instances of two-handed user input can be made into pairs of a one-handed input and a command paired with the two-handed user input to create training items. For example, a two-handed pull apart gesture input can be automatically labeled with a “zoom” label, creating a one-handed input with a “zoom” textual label, which is then paired with the two-handed pull apart gesture. This can help the model learn that receiving a similar one-handed gesture and the user's voice command of “zoom” should be mapped to the two-handed pull apart gesture.

In some implementations, the input translator can map a first portion of the single-handed user input to first hand input and a second portion of the single-handed user input to second hand input. For example, the user's hand movement may comprise two parts, the first part corresponding to a first hand's movement in a two-handed gesture and the second part corresponding to a second hand's movement in a two-handed gesture. In some implementations, a predefined input, such as a button press of a hand-held controller, a gesture (e.g., finger snap, thumbs up, hand-held controller shake, etc.), a voice command, a head or face motion (e.g., nod, blink, wink, etc.), body motion (e.g., torso twist, foot movement, etc.), or any other suitable signal, can separate the first portion of the single-handed input from the second portion of the singled-handed input. For example, a using performing a pull gesture in one direction with a hand, causing the trigger, then a pull gesture in the opposite direction with the same hand, can be translated to simultaneous opposing pull gestures, by different hands. To translate single-handed input with two portions, the input translator can map its two portions to the two hands of two-handed input.

The translated two-handed input can cause functionality at an artificial reality system, such as application functionality. In some implementations, the translated two-handed input can be used by software at the artificial reality system (e.g., system shell and/or artificial reality applications) to trigger functionality. Example triggered functionality includes opening a menu and/or selecting a menu item, zooming into a portion of an artificial reality environment or other display element, movement about an artificial reality environment related to two-handed input (e.g., avatar movement relative to the environment along with moving the user's view/perspective of the environment), using virtual tools (e.g., multiple virtual tools associated with two-handed use), holding a virtual object (e.g., with two hands), or any other suitable application functionality that can be triggered by two-handed user input.

Embodiments of the disclosed technology may include or be implemented in conjunction with an artificial reality system. Artificial reality or extra reality (XR) is a form of reality that has been adjusted in some manner before presentation to a user, which may include, e.g., virtual reality (VR), augmented reality (AR), mixed reality (MR), hybrid reality, or some combination and/or derivatives thereof. Artificial reality content may include completely generated content or generated content combined with captured content (e.g., real-world photographs). The artificial reality content may include video, audio, haptic feedback, or some combination thereof, any of which may be presented in a single channel or in multiple channels (such as stereo video that produces a three-dimensional effect to the viewer). Additionally, in some embodiments, artificial reality may be associated with applications, products, accessories, services, or some combination thereof, that are, e.g., used to create content in an artificial reality and/or used in (e.g., perform activities in) an artificial reality. The artificial reality system that provides the artificial reality content may be implemented on various platforms, including a head-mounted display (HMD) connected to a host computer system, a standalone HMD, a mobile device or computing system, a “cave” environment or other projection system, or any other hardware platform capable of providing artificial reality content to one or more viewers.

“Virtual reality” or “VR,” as used herein, refers to an immersive experience where a user's visual input is controlled by a computing system. “Augmented reality” or “AR” refers to systems where a user views images of the real world after they have passed through a computing system. For example, a tablet with a camera on the back can capture images of the real world and then display the images on the screen on the opposite side of the tablet from the camera. The tablet can process and adjust or “augment” the images as they pass through the system, such as by adding virtual objects. “Mixed reality” or “MR” refers to systems where light entering a user's eye is partially generated by a computing system and partially composes light reflected off objects in the real world. For example, a MR headset could be shaped as a pair of glasses with a pass-through display, which allows light from the real world to pass through a waveguide that simultaneously emits light from a projector in the MR headset, allowing the MR headset to present virtual objects intermixed with the real objects the user can see. “Artificial reality,” “extra reality,” or “XR,” as used herein, refers to any of VR, AR, MR, or any combination or hybrid thereof.

Conventional XR systems include a variety of input techniques, however these systems are limited in their solutions when input channels are unavailable. For example, a conventional XR system may fall back to a secondary input channel (e.g., gaze input) when a primary input channel (e.g., tracked user hands) is not available. This tiered approach to input channel utilization is limited in that some input channels are less conducive than others for certain interactions. Moreover, a user that is limited to or prefers providing part of an input channel (e.g., single-handed input) may be unnecessarily restricted by these conventional systems.

Implementations translate single-handed user input into two-handed input to improve the experience of users with limitations or preferences for single-handed mode. For example, single-handed user input can be translated into a two-handed gesture that triggers particular XR system and/or application functionality. Rather than falling back to a secondary input channel, implementations augment the single-handed user input with the translation functionality to enhance the interactions the user is capable of having with the XR system. Implementations also improve system accessibility for differently abled users, such as users with limited arm/hand mobility.

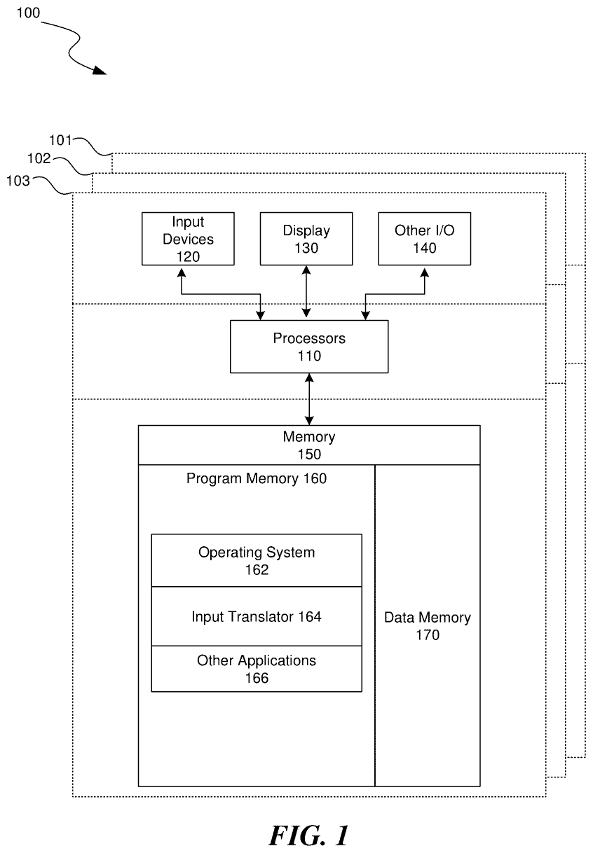

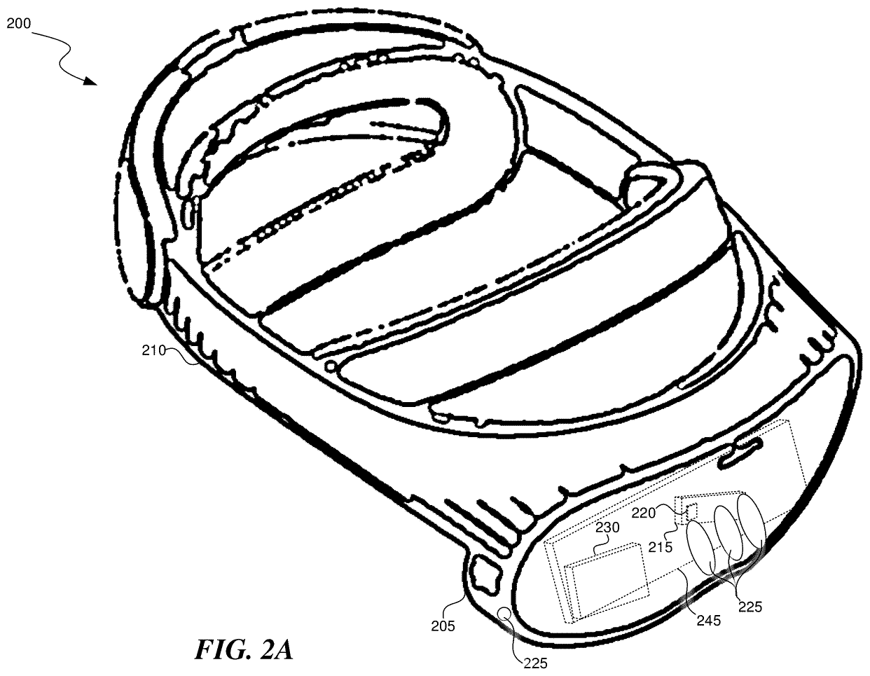

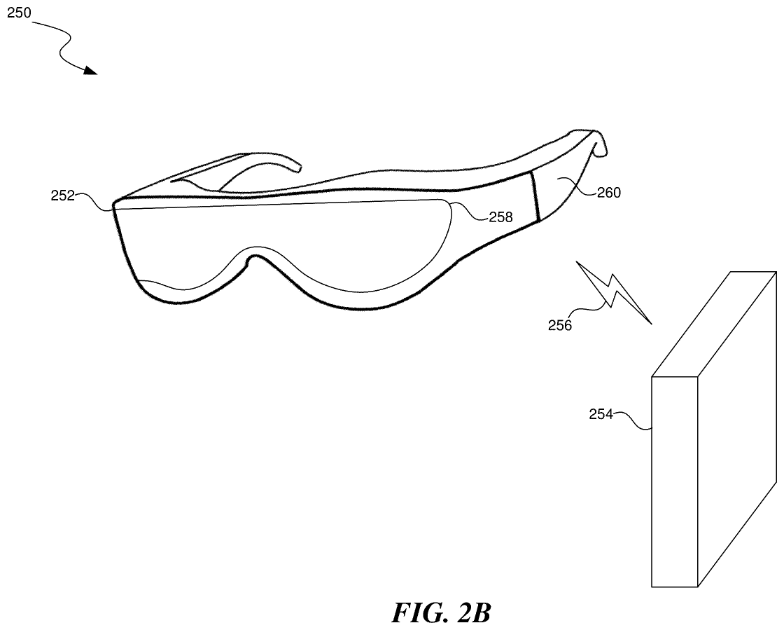

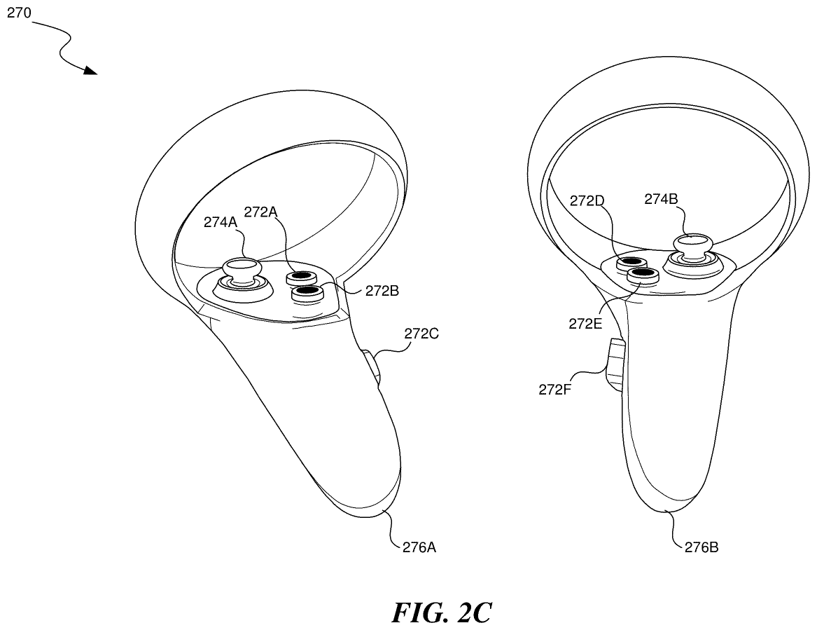

Several implementations are discussed below in more detail in reference to the figures. FIG. 1 is a block diagram illustrating an overview of devices on which some implementations of the disclosed technology can operate. The devices can comprise hardware components of a computing system 100 that operate an artificial reality (XR) system in single-handed mode. In various implementations, computing system 100 can include a single computing device 103 or multiple computing devices (e.g., computing device 101, computing device 102, and computing device 103) that communicate over wired or wireless channels to distribute processing and share input data. In some implementations, computing system 100 can include a stand-alone headset capable of providing a computer created or augmented experience for a user without the need for external processing or sensors. In other implementations, computing system 100 can include multiple computing devices such as a headset and a core processing component (such as a console, mobile device, or server system) where some processing operations are performed on the headset and others are offloaded to the core processing component. Example headsets are described below in relation to FIGS. 2A and 2B. In some implementations, position and environment data can be gathered only by sensors incorporated in the headset device, while in other implementations one or more of the non-headset computing devices can include sensor components that can track environment or position data.

Computing system 100 can include one or more processor(s) 110 (e.g., central processing units (CPUs), graphical processing units (GPUs), holographic processing units (HPUs), etc.) Processors 110 can be a single processing unit or multiple processing units in a device or distributed across multiple devices (e.g., distributed across two or more of computing devices 101-103).

Computing system 100 can include one or more input devices 120 that provide input to the processors 110, notifying them of actions. The actions can be mediated by a hardware controller that interprets the signals received from the input device and communicates the information to the processors 110 using a communication protocol. Each input device 120 can include, for example, a mouse, a keyboard, a touchscreen, a touchpad, a wearable input device (e.g., a haptics glove, a bracelet, a ring, an earring, a necklace, a watch, etc.), a camera (or other light-based input device, e.g., an infrared sensor), a microphone, or other user input devices.

Processors 110 can be coupled to other hardware devices, for example, with the use of an internal or external bus, such as a PCI bus, SCSI bus, or wireless connection. The processors 110 can communicate with a hardware controller for devices, such as for a display 130. Display 130 can be used to display text and graphics. In some implementations, display 130 includes the input device as part of the display, such as when the input device is a touchscreen or is equipped with an eye direction monitoring system. In some implementations, the display is separate from the input device. Examples of display devices are: an LCD display screen, an LED display screen, a projected, holographic, or augmented reality display (such as a heads-up display device or a head-mounted device), and so on. Other I/O devices 140 can also be coupled to the processor, such as a network chip or card, video chip or card, audio chip or card, USB, firewire or other external device, camera, printer, speakers, CD-ROM drive, DVD drive, disk drive, etc.

In some implementations, input from the I/O devices 140, such as cameras, depth sensors, IMU sensor, GPS units, LiDAR or other time-of-flights sensors, etc. can be used by the computing system 100 to identify and map the physical environment of the user while tracking the user's location within that environment. This simultaneous localization and mapping (SLAM) system can generate maps (e.g., topologies, grids, etc.) for an area (which may be a room, building, outdoor space, etc.) and/or obtain maps previously generated by computing system 100 or another computing system that had mapped the area. The SLAM system can track the user within the area based on factors such as GPS data, matching identified objects and structures to mapped objects and structures, monitoring acceleration and other position changes, etc.

Computing system 100 can include a communication device capable of communicating wirelessly or wire-based with other local computing devices or a network node. The communication device can communicate with another device or a server through a network using, for example, TCP/IP protocols. Computing system 100 can utilize the communication device to distribute operations across multiple network devices.

The processors 110 can have access to a memory 150, which can be contained on one of the computing devices of computing system 100 or can be distributed across of the multiple computing devices of computing system 100 or other external devices. A memory includes one or more hardware devices for volatile or non-volatile storage, and can include both read-only and writable memory. For example, a memory can include one or more of random access memory (RAM), various caches, CPU registers, read-only memory (ROM), and writable non-volatile memory, such as flash memory, hard drives, floppy disks, CDs, DVDs, magnetic storage devices, tape drives, and so forth. A memory is not a propagating signal divorced from underlying hardware; a memory is thus non-transitory. Memory 150 can include program memory 160 that stores programs and software, such as an operating system 162, input translator 164, and other application programs 166. Memory 150 can also include data memory 170 that can include, e.g., predefined mappings, training data, configuration data, settings, user options or preferences, etc., which can be provided to the program memory 160 or any element of the computing system 100.

Some implementations can be operational with numerous other computing system environments or configurations. Examples of computing systems, environments, and/or configurations that may be suitable for use with the technology include, but are not limited to, XR headsets, personal computers, server computers, handheld or laptop devices, cellular telephones, wearable electronics, gaming consoles, tablet devices, multiprocessor systems, microprocessor-based systems, set-top boxes, programmable consumer electronics, network PCs, minicomputers, mainframe computers, distributed computing environments that include any of the above systems or devices, or the like.

FIG. 2A is a wire diagram of a virtual reality head-mounted display (HMD) 200, in accordance with some embodiments. In this example, HMD 200 also includes augmented reality features, using passthrough cameras 225 to render portions of the real world, which can have computer generated overlays. The HMD 200 includes a front rigid body 205 and a band 210. The front rigid body 205 includes one or more electronic display elements of one or more electronic displays 245, an inertial motion unit (IMU) 215, one or more position sensors 220, cameras and locators 225, and one or more compute units 230. The position sensors 220, the IMU 215, and compute units 230 may be internal to the HMD 200 and may not be visible to the user. In various implementations, the IMU 215, position sensors 220, and cameras and locators 225 can track movement and location of the HMD 200 in the real world and in an artificial reality environment in three degrees of freedom (3DoF) or six degrees of freedom (6DoF). For example, locators 225 can emit infrared light beams which create light points on real objects around the HMD 200 and/or cameras 225 capture images of the real world and localize the HMD 200 within that real world environment. As another example, the IMU 215 can include e.g., one or more accelerometers, gyroscopes, magnetometers, other non-camera-based position, force, or orientation sensors, or combinations thereof, which can be used in the localization process. One or more cameras 225 integrated with the HMD 200 can detect the light points. Compute units 230 in the HMD 200 can use the detected light points and/or location points to extrapolate position and movement of the HMD 200 as well as to identify the shape and position of the real objects surrounding the HMD 200.

The electronic display(s) 245 can be integrated with the front rigid body 205 and can provide image light to a user as dictated by the compute units 230. In various embodiments, the electronic display 245 can be a single electronic display or multiple electronic displays (e.g., a display for each user eye). Examples of the electronic display 245 include: a liquid crystal display (LCD), an organic light-emitting diode (OLED) display, an active-matrix organic light-emitting diode display (AMOLED), a display including one or more quantum dot light-emitting diode (QOLED) sub-pixels, a projector unit (e.g., microLED, LASER, etc.), some other display, or some combination thereof.

In some implementations, the HMD 200 can be coupled to a core processing component such as a personal computer (PC) (not shown) and/or one or more external sensors (not shown). The external sensors can monitor the HMD 200 (e.g., via light emitted from the HMD 200) which the PC can use, in combination with output from the IMU 215 and position sensors 220, to determine the location and movement of the HMD 200.

FIG. 2B is a wire diagram of a mixed reality HMD system 250 which includes a mixed reality HMD 252 and a core processing component 254. The mixed reality HMD 252 and the core processing component 254 can communicate via a wireless connection (e.g., a 60 GHz link) as indicated by link 256. In other implementations, the mixed reality system 250 includes a headset only, without an external compute device or includes other wired or wireless connections between the mixed reality HMD 252 and the core processing component 254. The mixed reality HMD 252 includes a pass-through display 258 and a frame 260. The frame 260 can house various electronic components (not shown) such as light projectors (e.g., LASERs, LEDs, etc.), cameras, eye-tracking sensors, MEMS components, networking components, etc.

The projectors can be coupled to the pass-through display 258, e.g., via optical elements, to display media to a user. The optical elements can include one or more waveguide assemblies, reflectors, lenses, mirrors, collimators, gratings, etc., for directing light from the projectors to a user's eye. Image data can be transmitted from the core processing component 254 via link 256 to HMD 252. Controllers in the HMD 252 can convert the image data into light pulses from the projectors, which can be transmitted via the optical elements as output light to the user's eye. The output light can mix with light that passes through the display 258, allowing the output light to present virtual objects that appear as if they exist in the real world.

Similarly to the HMD 200, the HMD system 250 can also include motion and position tracking units, cameras, light sources, etc., which allow the HMD system 250 to, e.g., track itself in 3DoF or 6DoF, track portions of the user (e.g., hands, feet, head, or other body parts), map virtual objects to appear as stationary as the HMD 252 moves, and have virtual objects react to gestures and other real-world objects.

FIG. 2C illustrates controllers 270 (including controller 276A and 276B), which, in some implementations, a user can hold in one or both hands to interact with an artificial reality environment presented by the HMD 200 and/or HMD 250. The controllers 270 can be in communication with the HMDs, either directly or via an external device (e.g., core processing component 254). The controllers can have their own IMU units, position sensors, and/or can emit further light points. The HMD 200 or 250, external sensors, or sensors in the controllers can track these controller light points to determine the controller positions and/or orientations (e.g., to track the controllers in 3DoF or 6DoF). The compute units 230 in the HMD 200 or the core processing component 254 can use this tracking, in combination with IMU and position output, to monitor hand positions and motions of the user. The controllers can also include various buttons (e.g., buttons 272A-F) and/or joysticks (e.g., joysticks 274A-B), which a user can actuate to provide input and interact with objects.

In various implementations, the HMD 200 or 250 can also include additional subsystems, such as an eye tracking unit, an audio system, various network components, etc., to monitor indications of user interactions and intentions. For example, in some implementations, instead of or in addition to controllers, one or more cameras included in the HMD 200 or 250, or from external cameras, can monitor the positions and poses of the user's hands to determine gestures and other hand and body motions. As another example, one or more light sources can illuminate either or both of the user's eyes and the HMD 200 or 250 can use eye-facing cameras to capture a reflection of this light to determine eye position (e.g., based on set of reflections around the user's cornea), modeling the user's eye and determining a gaze direction.

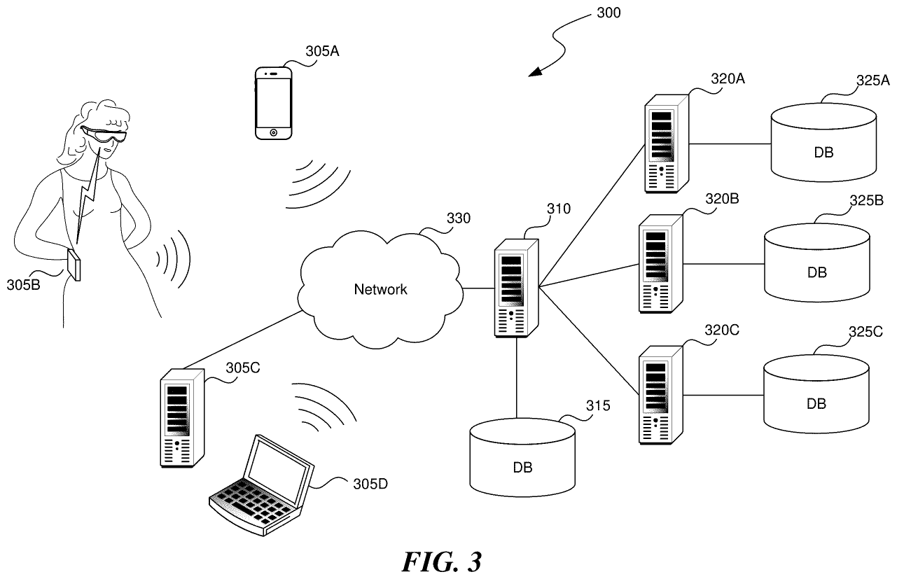

FIG. 3 is a block diagram illustrating an overview of an environment 300 in which some implementations of the disclosed technology can operate. Environment 300 can include one or more client computing devices 305A-D, examples of which can include computing system 100. In some implementations, some of the client computing devices (e.g., client computing device 305B) can be the HMD 200 or the HMD system 250. Client computing devices 305 can operate in a networked environment using logical connections through network 330 to one or more remote computers, such as a server computing device.

In some implementations, server 310 can be an edge server which receives client requests and coordinates fulfillment of those requests through other servers, such as servers 320A-C. Server computing devices 310 and 320 can comprise computing systems, such as computing system 100. Though each server computing device 310 and 320 is displayed logically as a single server, server computing devices can each be a distributed computing environment encompassing multiple computing devices located at the same or at geographically disparate physical locations.

Client computing devices 305 and server computing devices 310 and 320 can each act as a server or client to other server/client device(s). Server 310 can connect to a database 315. Servers 320A-C can each connect to a corresponding database 325A-C. As discussed above, each server 310 or 320 can correspond to a group of servers, and each of these servers can share a database or can have their own database. Though databases 315 and 325 are displayed logically as single units, databases 315 and 325 can each be a distributed computing environment encompassing multiple computing devices, can be located within their corresponding server, or can be located at the same or at geographically disparate physical locations.

Network 330 can be a local area network (LAN), a wide area network (WAN), a mesh network, a hybrid network, or other wired or wireless networks. Network 330 may be the Internet or some other public or private network. Client computing devices 305 can be connected to network 330 through a network interface, such as by wired or wireless communication. While the connections between server 310 and servers 320 are shown as separate connections, these connections can be any kind of local, wide area, wired, or wireless network, including network 330 or a separate public or private network.

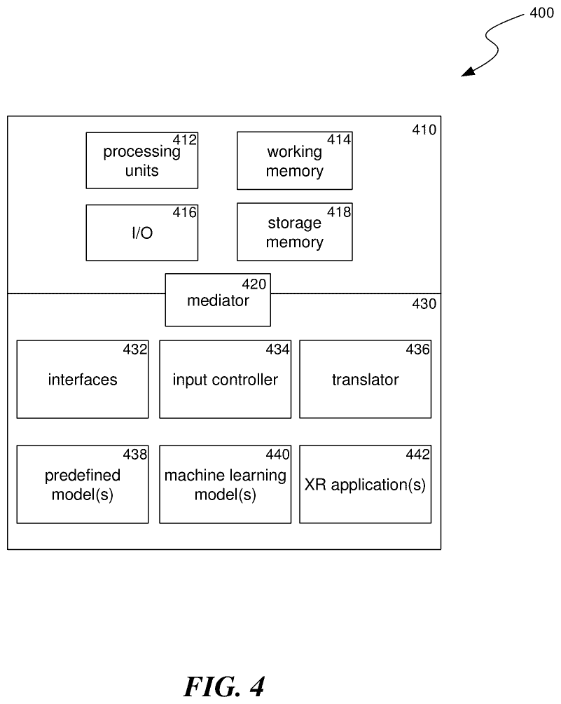

FIG. 4 is a block diagram illustrating components 400 which, in some implementations, can be used in a system employing the disclosed technology. Components 400 can be included in one device of computing system 100 or can be distributed across multiple of the devices of computing system 100. The components 400 include hardware 410, mediator 420, and specialized components 430. As discussed above, a system implementing the disclosed technology can use various hardware including processing units 412, working memory 414, input and output devices 416 (e.g., cameras, displays, IMU units, network connections, etc.), and storage memory 418. In various implementations, storage memory 418 can be one or more of: local devices, interfaces to remote storage devices, or combinations thereof. For example, storage memory 418 can be one or more hard drives or flash drives accessible through a system bus or can be a cloud storage provider (such as in storage 315 or 325) or other network storage accessible via one or more communications networks. In various implementations, components 400 can be implemented in a client computing device such as client computing devices 305 or on a server computing device, such as server computing device 310 or 320.

Mediator 420 can include components which mediate resources between hardware 410 and specialized components 430. For example, mediator 420 can include an operating system, services, drivers, a basic input output system (BIOS), controller circuits, or other hardware or software systems.

Specialized components 430 can include software or hardware configured to perform operations for operating an XR system in single-handed mode. Specialized components 430 can include input controller 434, translator 436, predefined model(s) 438, machine learning model(s) 440, XR application(s) 442, and components and APIs which can be used for providing user interfaces, transferring data, and controlling the specialized components, such as interfaces 432. In some implementations, components 400 can be in a computing system that is distributed across multiple computing devices or can be an interface to a server-based application executing one or more of specialized components 430. Although depicted as separate components, specialized components 430 may be logical or other nonphysical differentiations of functions and/or may be submodules or code-blocks of one or more applications.

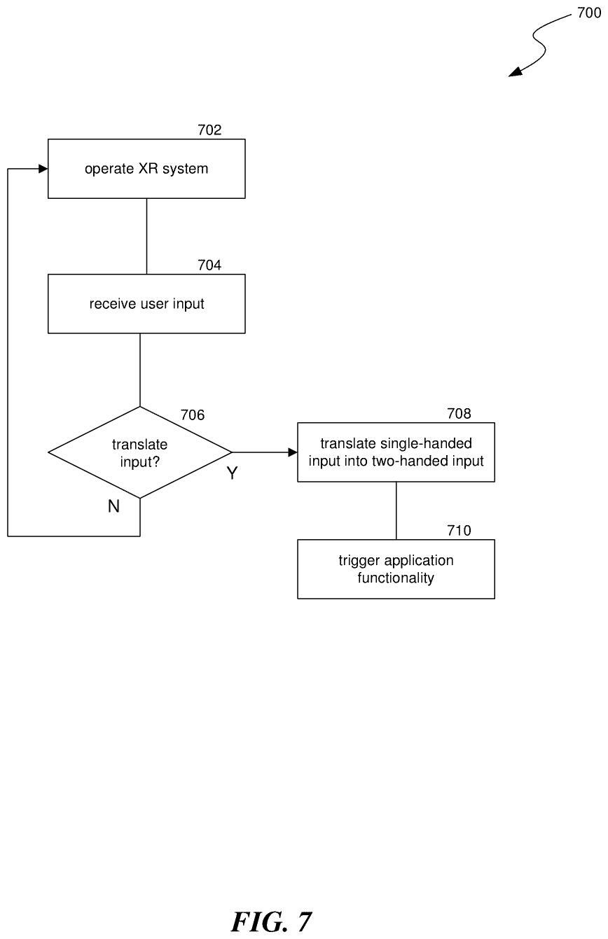

Input controller 434 can receive input from a user of an XR system. The input from a user can be received via a variety of input channels, such as hand-held controllers, tracked hand movement, gaze input, tracked head movement, tracked body movement, tracked controller movement or button presses, voice input, and any other suitable input from a user. In some scenarios, the received input can be single-handed input that is provide to translator 436 for translation to two-handed input. Input received from the user can cause application functionality at an XR system, such as via XR application(s) 442. In some implementations, input controller 434 can provide input for translation to translator 436 when the XR system is operating in single-handed mode. Additional details on input controller 434 are provided below in relation to block 702, 704, and 706 of FIG. 7.

Translator 436 can translate single-handed user input into two-handed input. For example, translator 436 can translate single-handed user input into two-handed user input by: simulating additional input corresponding to the single-handed user input; predicting, using a trained machine learning model, the two-handed input based on the single-handed user input; combining the single-handed user input and a second user input provided in a mode other than a hand gesture; and/or mapping a first portion of the single-handed user input to first hand input and mapping a second portion of the single-handed user input to second hand input. Additional details on translator 436 are provided below in relation to block 708 of FIG. 7.

Predefined model(s) 438 can define associations between user input and techniques to translate single-handed input into two-handed input. In some implementations, predefined model(s) 438 can be rule-based models with conditions that trigger translation actions. An example of a rule can include: a) (conditions) while operating in single-handed mode AND when a predefined button of a hand-held controller is pressed or held AND the button press/hold occurs during detected movement; b) (triggered translation action) generate simulated input that corresponds to a mirror of the single-handed input (e.g., detected motion while the button is press/held). The rules of predefined model(s) 438 can be based on user settings, default settings, or any other suitable source for associations between input conditions and translation actions. Additional details on predefined model(s) 438 are provided below in relation to blocks 706 and 708 of FIG. 7.

Machine learning model(s) 440 can be models used to process visual data, sensor data, voice, or any other suitable data. Examples of machine learning model(s) 440 can be natural language processing models, computer vision models that process images/video, generative machine learning models, neural networks, deep neural networks, convolutional neural networks, deep convolutional neural networks, transformer networks, encoders and decoders, generative adversarial networks (GANS), large language models, support vector machines, Parzen windows, Bayes, clustering models, reinforcement models, probability distributions, decision trees, decision tree forests, and other suitable machine learning. In some implementations, machine learning model(s) 440 can comprise multiple stacked models, an ensemble model, or any other suitable architecture comprising multiple models. Additional details on machine learning model(s) 440 are provided below in relation to block 708 of FIG. 7.

XR application(s) 442 can include two-dimensional or immersive applications for execution, at least in part, at an XR system. Example applications include web browsers, music players, video players, social media applications, messaging or other communication applications, third-party applications, streaming/casting applications, a content library application, games, or any other suitable application. XR application(s) 442 executing at an XR application can be responsive to user input, such as trigger application functionality in response to user input (e.g., single-handed user input) and/or two-handed input translated by translator 436. Additional details on XR applications 442 are provided below in relation to block 710 of FIG. 7.

A “machine learning model,” as used herein, refers to a construct that is configured (e.g., trained using training data) to make predictions, provide probabilities, augment data, and/or generate data. For example, training data for supervised learning can include items with various parameters and an assigned classification. A new data item can have parameters that a model can use to assign a classification to the new data item. Machine learning models can be configured for various situations, data types, sources, and output formats.

Training data can be any set of data capable of training machine learning model(s), such as a set of features with corresponding labels for supervised learning. Training data can be used to train machine learning model(s) to generate trained machine learning model(s). For example, any suitable training technique (e.g., supervised training via gradient descent, unsupervised training, etc.) can be used to update a configuration of machine learning model(s) (e.g., train the weights of a machine learning model) using training data.

The architecture of implemented machine learning model(s) can include any suitable machine learning model components (e.g., a neural network, support vector machine, specialized regression model, random forest classifier, gradient boosting classifier, and the like). For example, a neural network can be implemented along with a given cost function (e.g., for training/gradient calculation). The neural network can include any number of hidden layers (e.g., 0, 1, 2, 3, or many more), and can include feed forward neural networks, recurrent neural networks, convolution neural networks, transformer networks, encoder-decoder architectures, large language model(s), and any other suitable type. In some implementations, the neural network can be configured for deep learning, for example based on the number of hidden layers implemented. In some implementations, machine learning model(s) can be an ensemble learning model. Multiple models can be stacked, for example with the output of a first model feeding into the input of a second model. Some implementations can include a number of layers of prediction models. In some implementations, features utilized by machine learning model(s) can also be determined, for example via any suitable feature engineering techniques.

In some implementations, machine learning model(s) can be trained to predict two-handed input from single-handed user input. For example, machine learning model(s) can be trained using training data that comprises historic instances of two-handed user input, such as instances that correspond to two-handed gestures (e.g., clapping, stretching out two hands, a stop signal via two hands cross-crossing, two-handed dance moves, etc.). The training data can be aggregated by detecting, using a computer vision model and/or any suitable machine learning model(s) configured to process XR system sensor data, two-handed gestures performed by a user (e.g., two-handed movement gestures, gestures using two hand-held controllers, etc.) and correlating input (e.g., two-handed user input signals) received from the user that corresponds to the detected two-handed gestures. An instance of historic two-handed user input can be processed into a training instance that comprises: single-handed user input (e.g., separated from the two-handed user input), and the two-handed user input from which the single-handed use input was separated (e.g., two-handed input that corresponds to a detected gesture). The training data can train the machine learning model(s) to generate a two-handed input prediction (e.g., input that corresponds to a two-handed gesture) that likely corresponds to single-handed user input provided by a user.

In some implementations, trained machine learning model(s) can understand voice input from the user. For example, natural language processing model(s) can understand, using voice input and/or a transcript of the voice input, utterances from a user. The utterances can be used to configure the translation of single-handed user input into two-handed input. For example, machine learning model(s) can be trained to predict a two-handed gesturing using single-handed user input from the user and voice input from the user (e.g., a semantic representation of the user's voice input). In some cases, machine learning model(s), can be trained using training data that is based on historic instances of two-handed user input. For each training instance-input to the model can be a single hand input combined with a label such as a textual description of the resulting two-handed user input, where another model can be used to evaluate the result of the two-handed user input to generate the textual description, and the output for that training instance (to be compared to the model output for updating model parameters in training) can be the actual two-handed user input. Thus, the historic instances of two-handed user input can be made into pairs of A) a one-handed input and a command paired with B) the two-handed user input to create training items. For example, a two-handed pull apart gesture input can be automatically labeled with a “zoom” label, creating a one-handed input with a “zoom” textual label, which is then paired with the two-handed pull apart gesture. This can help the model learn that receiving a similar one-handed gesture and the user's voice command of “zoom” should be mapped to the two-handed pull apart gesture.

In some implementations, machine learning model(s) can compare features of the single-handed user input to features of predefined two-handed gesture to generate probabilities that the single-handed user input corresponds to the predefined two-handed gestures. The predefined two-handed gestures can also comprise one or more natural language tags, such as names, descriptions of the gesture, and the like. In some implementations, machine learning model(s) can also compare the user's voice utterance to the natural language tags to generate probabilities that the voice input corresponds to the predefined two-handed gestures. These probabilities can be combined to predict at least one two-handed gesture that corresponds to the single-handed user input and voice input.

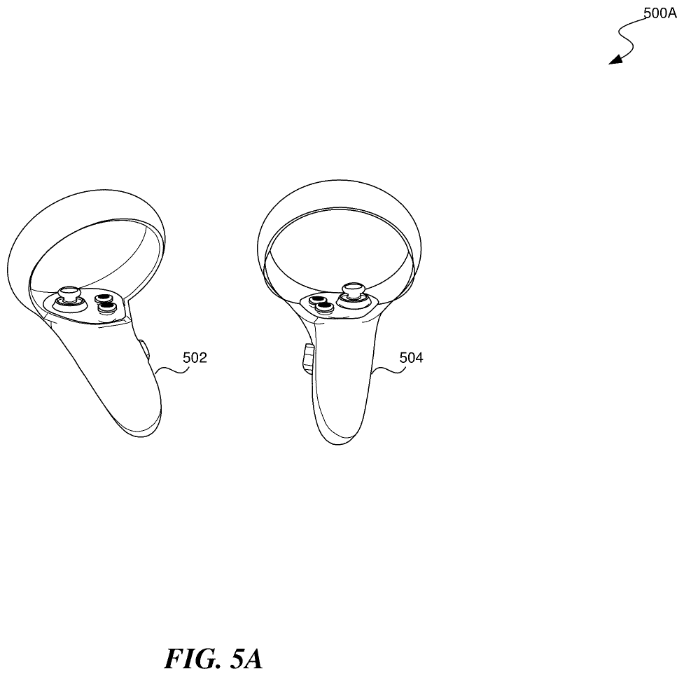

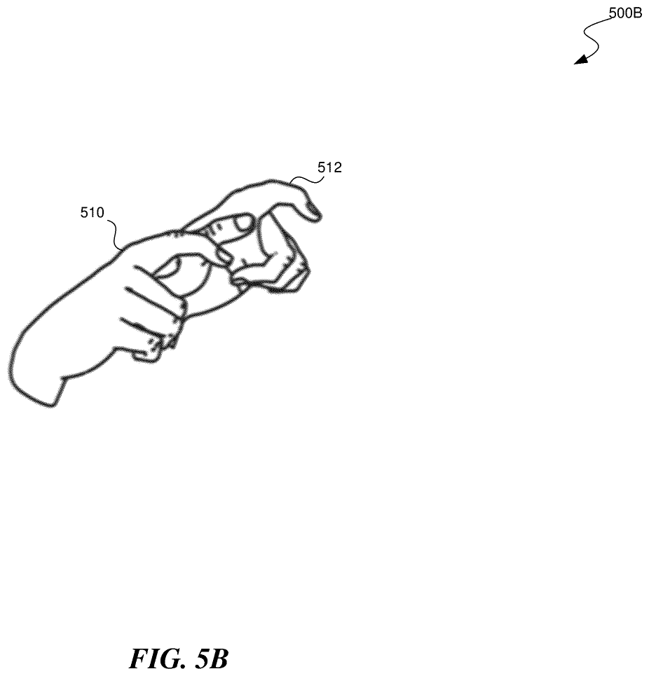

In some implementations, translating single-handed user input into two-handed input improves user interactions with an XR system. FIG. 5A is a conceptual diagram 500A illustrating hand-held controllers used to provide input to an artificial reality system. Diagram 500A includes hand-held controllers 502 and 504. While conventional XR systems often receive input from two hand-held controllers, some individuals may comprise physical limitations and/or prefer not to utilize two controllers. For example, controller 504 may be missing, be outside tracking parameters, have a low or dead batter, etc., such that only controller 502 provides hand-held controller input to the XR system. In this scenario, controller 502 can provide single-handed input to the XR system. As a result, certain inputs, such as predefined two-handed gestures or other two-handed movements/input patterns, may be impractical or impossible. Some XR systems may utilize tracked hand movement that causes similar restrictions.

FIG. 5B is a conceptual diagram 500B illustrating two hands used to provide input to an artificial reality system. Diagram 500B includes hands 510 and 512. Conventional XR systems may track movement of both hand 510 and hand 512 to support XR system interactions. However, individuals that comprise physical limitations and/or prefer not to utilize two hands may be restricted to singled-handed user input. For example, tracked movement of hand 512 may be missing as an input channel such that only tracked movement of hand 510 provides tracked hand input to the XR system. In this scenario, tracked movement of hand 510 can provide single-handed input to the XR system, and certain inputs, such as predefined two-handed gestures or other two-handed movements/input patterns, may be impractical or impossible.

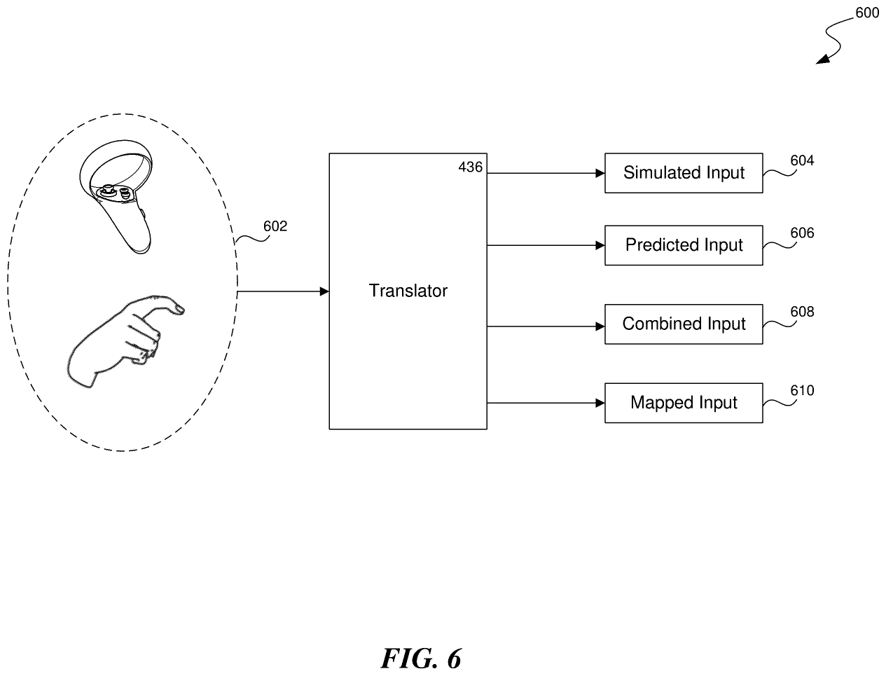

Implementations can provide single-handed user input, such as input from hand-held controller 502 or detected movement of hand 510, to an input translator that translates the single-handed input into two-handed input. FIG. 6 is a conceptual diagram 600 illustrating an input translator used to translate single-handed input into two-handed input. Diagram 600 includes single-handed input source 602, simulated input 604, predicted input 606, combined input 608, and mapped input 610, as well as translator 436 of FIG. 4.

As described with reference to FIGS. 5A and 5B, single-handed input source 602 can be single hand-held controller or the tracked motion of a single hand. The single-handed input provided by single-handed input source 602 can be processed by translator 436 to generate one or more of simulated input 604, predicted input 606, combined input 608, and/or mapped input 610. For example, predefined model(s) can define associations between user input and techniques to translate single-handed input into two-handed input. In some implementations, predefined models(s) can associate certain auxiliary input, such as head movement, gaze input, button presses at a hand-held controller, etc., with combination techniques with respect to one-handed input. For example, holding down a button while moving a hand-held controller may indicate that the user's voice input should be combined with the hand-held controller movement to translate the input into two-handed input (e.g., generate combined input 608). In another example, a predefined head movement (e.g., nodding gesture) may indicate the tracked movement of a single user hand should be provided to trained machine learning model(s) to predict two-handed input based on the single-handed user input (e.g., generate predicted input 606).

In some implementations, predefined model(s) can be rule-based models with conditions that trigger translation actions. An example of a rule can include: a) (conditions) while operating in single-handed mode AND when a predefined voice command is received along with single-handed user input; b) (triggered translation action) generate predicted input 606 by predicting two-handed input using the single-handed input via trained machine learning model(s). The rules can be based on user settings, default settings, or any other suitable source for associations between input conditions and translation actions. Any other suitable rules can trigger translator 436 to translate single-handed user input into two-handed input via generating one or more of simulated input 604, predicted input 606, combined input 608, and/or mapped input 610.

In some implementations, translator 436 can generate, using the single-handed user input, simulated input 604. Simulated input 604 can be a mirror of the single-handed user input. For example, some hand gestures include two hands performing two parts of a gesture, where the two parts are mirror images of one another, such as a “clapping” gesture. Translator 436 can simulate input that mirrors the single-handed user input from the perspective of a second hand, such as by inverting a direction of detected motion.

In some implementations, mirroring the single-handed user input includes replicating and adjusting (e.g., inverting) movement data over a period of time (e.g., the last/next 0.5 seconds movement, 1 second of movement, 1.5 seconds of movement, etc.). For example, controller/hand movement can include tracked movement subcomponents (e.g., 6DOF movement components, multiple movement vectors, etc.), and one or more of these movement subcomponents can be inverted to simulate the mirrored input for the second hand. In some implementations, adjusting the movement data can include filtering one or more of the movement subcomponents. In some implementations, simulated input 604 combined with the initial single-handed input can comprise the translated two-handed input. For example, once combined simulated input 604 and the single-handed input can correspond to a two-handed gesture, movement pattern, etc.

In some implementations, translator 436 can predict, using a trained machine learning model, predicted input 606, such as two-handed input, based on the single-handed user input. For example, machine learning model(s) can be trained using training data that comprises historic instances of two-handed user input, such as instances that correspond to two-handed gestures. An instance of historic two-handed user input can be processed into a training instance of: single-handed user input (e.g., half the historic two-handed user input), and the two-handed user input from which the single-handed use input was derived (e.g., two-handed input that corresponds to a predefined gesture). The training data can train the machine learning model(s) to generate predicted input 606, or a two-handed input prediction (e.g., input that corresponds to a predefined gesture) that likely corresponds to the single-handed user input provided by a user.

In some implementations, predicted input 606 combined with the initial single-handed input can comprise the translated two-handed input. In some implementations, predicted input 606 can comprise a predefined two-handed gesture itself (e.g., input signals that correspond to input from two hands or two-handheld controllers performing the two-handed gesture). In this example, predicted input 606 can comprise the translated two-handed input.

In some implementations, translator 436 can combine single-handed user input and a second user input provided in another mode, such as voice input, gaze input, head movement, button-press input at a hand-held controller, and the like to generate combined input 608. For example, the user can provide voice input associated with the single-handed input, such as language that describes/names a two-handed gesture (e.g., “grab with two hands”) while providing single-handed user input (e.g., moving the user's single hand to perform a grab gesture). Translator 436 can use trained machine learning model(s) to generate likelihoods for predefined two-handed gestures/movement patterns that match: the single-handed user input; and the voice input.

For example, a set of predefined two-handed gestures/movement patterns can comprise features of the hand movements and natural language tags (e.g., descriptions, names, etc.) The machine learning model(s) can generate likelihoods with respect to one or more of the predefined two-handed gestures/movement patterns matching the single-handed user input (e.g. based on similarity to the movement patterns) and likelihoods with respect to one or more of the predefined two-handed gestures/movement patterns matching the voice input (e.g., based on similarity with the natural language tags). The predicted likelihoods can be combined to predict a matching predefined gesture, or combined input 608.

In some implementations, combined input 608 together with the initial single-handed input can comprise the translated two-handed input. For example, combined input 608 can comprise half the input signals associated with a two-handed gesture/movement pattern. In some implementations, combined input 608 can comprise a predefined two-handed gesture/movement pattern itself (e.g., input signals that correspond to input from two hands or two-handheld controllers performing the two-handed gesture). In this example, combined input 608 can comprise the translated two-handed input.

In some implementations, translator 436 can map a first portion of the single-handed user input to first hand input and a second portion of the single-handed user input to second hand input to generate mapped input 610. For example, the user's single-hand input may comprise two parts, the first part corresponding to a first hand's movement in a two-handed gesture/movement pattern and the second part corresponding to a second hand's movement in a two-handed gesture/movement pattern. In some implementations, a predefined signal from the user, such as a button press of a hand-held controller, a gesture (e.g., finger snap, thumbs up, hand-held controller shake, etc.), or any other suitable signal, can separate the first portion of the single-handed input from the second portion of the singled handed input. To translate single-handed input with two portions, translator 436 can: map the first portion of the single-handed input to a first hand and map the second portion of the single-handed input to a second hand; and aggregate the mapped first hand and mapped second hand to generate mapped input 610.

The two-handed input translated by translator 437 can cause XR system functionality. For example, executing software at the XR system (e.g., XR applications, a system shell, etc.) can perform functions and/or trigger interactions via the two-handed input translated. Accordingly, one-handed user input can be translated to two-handed input to cause XR application and/or XR system shell functionality.

Those skilled in the art will appreciate that the components illustrated in FIGS. 1-4, 5A, 5B, and 6 described above, and in each of the flow diagrams discussed below, may be altered in a variety of ways. For example, the order of the logic may be rearranged, substeps may be performed in parallel, illustrated logic may be omitted, other logic may be included, etc. In some implementations, one or more of the components described above can execute one or more of the processes described below.

FIG. 7 is a flow diagram illustrating a process 700 used in some implementations of the present technology for operating an artificial reality system in single-handed mode. Process 700 can be performed by an XR system, a mobile device (e.g., smartphone, tablet, etc.), cloud or edge computing device, personal computing device (e.g., laptop, desktop, smart home device, etc.), wearable device (e.g., smart glasses, etc.), any combination thereof, or any other suitable computing device(s). Process 700 can be triggered in response to a user operating an XR system and/or in response to single-handed mode at an XR system.

At block 702, process 700 can operate an XR system. For example, an XR system can generate displays for a user (e.g., an XR environment, two-dimensional displays, etc.), receive input from a user, execute software to perform XR system functionality (e.g., XR applications, a system shell, etc.), and the like. In some implementations, the XR system may operate in single-handed mode, for example based on a user setting, input from the user the initiates/maintains single-handed mode, and the like.

At block 704, process 700 can receive user input. For example, a user of the XR system can provide input via any suitable inputs channels, such as gaze input, hand-held controller input, tracked hand movement, voice input, tracked head movement, and the like.

At block 706, process 700 can determine whether to translate the user input. For example, the received user input may comprise single-handed input for translation at the XR system. It can be determined that user input should be translated when: the XR system operates in single-handed mode; and a signal from the user indicates that associated input (e.g., input before and/or after the signal for a predetermined period of time) should be translated. Example signals from the user include a button press, a voice/audible signal, a user gesture, or any other suitable signal. In some implementations, single-handed input (e.g., input from a single hand-held controller or tracked movement of a single hand) can be provided for translation by default while the XR system operates in single-handed mode. In various implementations, single-handed mode can be initiated by a user command (e.g., permanent setting, voice command, enablement of a UI element, etc.) or in response to a system inference (e.g., when the system can only locate one hand or controller, when one controller has recently lost battery power, when one hand or controller is identified as not moving for above a threshold amount of time, etc.).

In some implementations, a state of executing software, such as an XR application, can indicate that single-handed input should be translated. For example, an immersive application, or any other suitable XR application, may comprise an event where two-handed gestures are relevant to the user experience. In this example, the executing software may raise a flag that is observed by a system shell (e.g., input controller 434 of FIG. 4), and the system shell may determine that single-handed input should be provided for translation at least until the flag is no longer raised. Any other suitable technique can be used to determine that user input should be translated.

When it is determined that the user input should be translated, process 700 can progress to block 708. When it is determined that the user input should not be translated, process 700 can loop back to block 702, where the XR system can continue to be operated. For example, when the user input is not translated, the user input can cause XR system functionality according to conventional interactions between a user and an XR system.

At block 708, process 700 can translate single-handed user input into two-handed input. For example, single-handed user input can be translated into two-handed user input by: simulating additional input corresponding to the single-handed user input; predicting, using a trained machine learning model, the two-handed input based on the single-handed user input; combining the single-handed user input and a second user input provided in a mode other than a hand gesture; and/or mapping a first portion of the single-handed user input to first hand input and mapping a second portion of the single-handed user input to second hand input.

In some implementations, the input translator can simulate, using the single-handed user input, additional input. The additional input can be a mirror of the single-handed user input, such as to simulate input from a second hand. For example, some hand gestures include two hands performing two parts of a gesture, where the two parts are mirror images of one another. The input translator can simulate input that mirrors the single-handed user input from the perspective of a second hand, such as by inverting a direction of detected motion.

In some implementations, the input translator can predict, using a trained machine learning model, two-handed input based on the single-handed user input. For example, the trained machine learning model is trained to receive single-handed user input and predict two-handed user input. In some implementations, training data for the trained machine learning model is aggregated from historic two-handed user input comprising two-handed movement data and/or two-handed hand-held controller data, and each training instance of the training data comprises an instance of the historic two-handed user input and one-handed input derived from the instance of two-handed user input. The machine learning model can be trained by generating two-handed input predictions using the one-handed input from the training instances such that weights of the model are altered based on a difference between the two-handed input predictions and historic two-handed user input from the training instances.

In some implementations, the input translator can combine single-handed user input and a second user input provided in another mode, such as voice input, gaze input, head movement, button-press input at a hand-held controller, and the like. For example, the single-handed user input can be detected movement from the single hand of the user or the input from the single hand-held controller and the second user input can be voice input from the user. The second user input can be any other suitable input in a mode other than hand gesture/hand movement.

In some implementations, the input translator can map a first portion of the single-handed user input to first hand input and a second portion of the single-handed user input to second hand input. For example, the user's hand movement may comprise two parts, the first part corresponding to a first hand's movement in a two-handed gesture/movement pattern and the second part corresponding to a second hand's movement in a two-handed gesture/movement pattern. In some implementations, a predefined signal, such as a button press of a hand-held controller, a gesture (e.g., finger snap, thumbs up, hand-held controller shake, etc.), a voice command, a head or face motion (e.g., nod, blink, wink, etc.), body motion (e.g., torso twist, foot movement, etc.), or any other suitable signal, can separate the first portion of the single-handed input from the second portion of the single-handed input.

To translate single-handed input with two portions, the input translator can map its two portions to the two hands of two-handed input. For example, the first portion can be detected movement from the single hand of the user or the input from the single hand-held controller at a first time, the second portion can be detected movement from the single hand of the user or the input from the single hand-held controller at a second time, and the second portion can simulate input from a second hand or second hand-held controller.

At block 710, process 700 can trigger application functionality based on the translated two-handed input. For example, the translated two-handed input can cause functionality at an XR system, such as functionality of executing software (e.g., XR application, system shell, etc.). Example triggered functionality includes opening a menu and/or selecting a menu item, zooming into a portion of an artificial reality environment or other display element, movement about an artificial reality environment related to two-handed input (e.g., avatar movement relative to the environment along with moving the user's view/perspective of the environment), using virtual tools (e.g., multiple virtual tools associated with two-handed use), holding a virtual object (e.g., with two hands), or any other suitable application functionality that can be triggered by two-handed user input.

In some implementations, the application functionality can be triggered in response to the translated two-handed input mapping to a predefined two-handed gesture/movement pattern. Example two-handed gestures/movement patterns include: a clapping gesture, a pulling apart gesture, a compressing gesture (e.g., bringing two hands together with open palms), a gesture with portions that alternate between hands, or any other suitable two-handed gesture/movement pattern.

Several implementations of the disclosed technology are described above in reference to the figures. The computing devices on which the described technology may be implemented can include one or more central processing units, memory, input devices (e.g., keyboard and pointing devices), output devices (e.g., display devices), storage devices (e.g., disk drives), and network devices (e.g., network interfaces). The memory and storage devices are computer-readable storage media that can store instructions that implement at least portions of the described technology. In addition, the data structures and message structures can be stored or transmitted via a data transmission medium, such as a signal on a communications link. Various communications links can be used, such as the Internet, a local area network, a wide area network, or a point-to-point dial-up connection. Thus, computer-readable media can comprise computer-readable storage media (e.g., “non-transitory” media) and computer-readable transmission media.

Reference in this specification to “implementations” (e.g., “some implementations,” “various implementations,” “one implementation,” “an implementation,” etc.) means that a particular feature, structure, or characteristic described in connection with the implementation is included in at least one implementation of the disclosure. The appearances of these phrases in various places in the specification are not necessarily all referring to the same implementation, nor are separate or alternative implementations mutually exclusive of other implementations. Moreover, various features are described which may be exhibited by some implementations and not by others. Similarly, various requirements are described which may be requirements for some implementations but not for other implementations.

As used herein, being above a threshold means that a value for an item under comparison is above a specified other value, that an item under comparison is among a certain specified number of items with the largest value, or that an item under comparison has a value within a specified top percentage value. As used herein, being below a threshold means that a value for an item under comparison is below a specified other value, that an item under comparison is among a certain specified number of items with the smallest value, or that an item under comparison has a value within a specified bottom percentage value. As used herein, being within a threshold means that a value for an item under comparison is between two specified other values, that an item under comparison is among a middle-specified number of items, or that an item under comparison has a value within a middle-specified percentage range. Relative terms, such as high or unimportant, when not otherwise defined, can be understood as assigning a value and determining how that value compares to an established threshold. For example, the phrase “selecting a fast connection” can be understood to mean selecting a connection that has a value assigned corresponding to its connection speed that is above a threshold.

As used herein, the word “or” refers to any possible permutation of a set of items. For example, the phrase “A, B, or C” refers to at least one of A, B, C, or any combination thereof, such as any of: A; B; C; A and B; A and C; B and C; A, B, and C; or multiple of any item such as A and A; B, B, and C; A, A, B, C, and C; etc.

Although the subject matter has been described in language specific to structural features and/or methodological acts, it is to be understood that the subject matter defined in the appended claims is not necessarily limited to the specific features or acts described above. Specific embodiments and implementations have been described herein for purposes of illustration, but various modifications can be made without deviating from the scope of the embodiments and implementations. The specific features and acts described above are disclosed as example forms of implementing the claims that follow. Accordingly, the embodiments and implementations are not limited except as by the appended claims.

Any patents, patent applications, and other references noted above are incorporated herein by reference. Aspects can be modified, if necessary, to employ the systems, functions, and concepts of the various references described above to provide yet further implementations. If statements or subject matter in a document incorporated by reference conflicts with statements or subject matter of this application, then this application shall control.

I/We claim:

1. A method for operating an artificial reality (XR) system in single-handed mode, the method comprising:
receiving single-handed user input that comprises detected movement from a single hand of the user or input from a single hand-held controller;
translating, in response to the XR system operating in single-handed mode, the single-handed user input into two-handed input by one or more of:
simulating additional input corresponding to the single-handed user input;
predicting, using a trained machine learning model, the two-handed input based on the single-handed user input;
combining the single-handed user input and a second user input provided in a mode other than a hand gesture; or
mapping a first portion of the single-handed user input to a first hand input and mapping a second portion of the single-handed user input to a second hand input; and
causing application functionality triggered by the translated two-handed input.

2. The method of claim 1, wherein,
the single-handed user input is translated by simulating additional input, and simulating additional input comprises mirroring the single-handed user input to simulate input from a second hand or second hand-held controller.

3. The method of claim 1, wherein,
the single-handed user input is translated by combining the single-handed user input and a second user input provided in a mode other than a hand gesture,
the single-handed user input comprises detected movement from the single hand of the user or the input from the single hand-held controller, and
the second user input comprises voice input from the user.

4. The method of claim 1, wherein,
the single-handed user input is translated by mapping a first portion of the single-handed user input to a first hand input and mapping a second portion of the single-handed user input to a second hand input,
the first portion comprises the detected movement from the single hand of the user or the input from the single hand-held controller at a first time,
the second portion comprises detected movement from the single hand of the user or the input from the single hand-held controller at a second time, and
the second portion simulates input from a second hand or second hand-held controller.

5. The method of claim 4, wherein a signal comprised by the single-handed user input indicates a transition between the first portion and the second portion.

6. The method of claim 1, wherein,
the single-handed user input is translated by predicting, using the trained machine learning model, the two-handed input based on the single-handed user input, and
the trained machine learning model is trained to receive single-handed user input and predict two-handed user input.

7. The method of claim 6, wherein,
training data for the trained machine learning model is aggregated from historic two-handed user input comprising two-handed movement data and/or two-handed hand-held controller data,
each training instance of the training data comprises an instance of the historic two-handed user input and one-handed input derived from the instance of two-handed user input, and
the machine learning model is trained by generating two-handed input predictions using the one-handed input from the training instances such that weights of the model are altered based on a difference between the two-handed input predictions and historic two-handed user input from the training instances.

8. The method of claim 1, wherein the application functionality triggered by the translated two-handed input comprises one or more of:
opening a menu or menu item;
zooming in on a display the XR system displays to the user;
movement comprising avatar movement relative to an XR environment and altering the user's view of the XR environment;
utilizing multiple virtual tools associated with two-handed use; or
any combination thereof.

9. The method of claim 1, wherein the application functionality is triggered in response to the translated two-handed input mapping to a predefined two-handed gesture.

10. The method of claim 9, wherein the predefined two-handed gesture comprises one or more of:
a clapping gesture;
a pulling apart gesture;
a compressing gesture; or
a gesture with portions that alternate between two hands.

11. A computer-readable storage medium storing instructions that, when executed by a computing system, cause the computing system to perform a process for operating an artificial reality (XR) system in single-handed mode, the process comprising:
receiving single-handed user input that comprises detected movement from a single hand of the user or input from a single hand-held controller;
translating, in response to the XR system operating in single-handed mode, the single-handed user input into two-handed input by one or more of:
simulating additional input corresponding to the single-handed user input;
predicting, using a trained machine learning model, the two-handed input based on the single-handed user input;
combining the single-handed user input and a second user input provided in a mode other than a hand gesture; or
mapping a first portion of the single-handed user input to a first hand input and mapping a second portion of the single-handed user input to a second hand input; and
causing application functionality triggered by the translated two-handed input.

12. The computer-readable storage medium of claim 11, wherein,
the single-handed user input is translated by simulating additional input, and
simulating additional input comprises mirroring the single-handed user input to simulate input from a second hand or second hand-held controller.

13. The computer-readable storage medium of claim 11, wherein,
the single-handed user input is translated by combining the single-handed user input and a second user input provided in a mode other than a hand gesture,
the single-handed user input comprises detected movement from the single hand of the user or the input from the single hand-held controller, and
the second user input comprises voice input from the user.

14. The computer-readable storage medium of claim 11, wherein,
the single-handed user input is translated by mapping a first portion of the single-handed user input to a first hand input and mapping a second portion of the single-handed user input to a second hand input,
the first portion comprises the detected movement from the single hand of the user or the input from the single hand-held controller at a first time,
the second portion comprises detected movement from the single hand of the user or the input from the single hand-held controller at a second time,
the second portion simulates input from a second hand or second hand-held controller, and
a signal comprised by the single-handed user input indicates a transition between the first portion and the second portion.

15. The computer-readable storage medium of claim 11, wherein,
the single-handed user input is translated by predicting, using the trained machine learning model, the two-handed input based on the single-handed user input, and
the trained machine learning model is trained to receive single-handed user input and predict two-handed user input.

16. The computer-readable storage medium of claim 11, wherein the application functionality triggered by the translated two-handed input comprises one or more of:
opening a menu or menu item;
zooming in on a display the XR system displays to the user;
movement comprising avatar movement relative to an XR environment and altering the user's view of the XR environment; or
utilizing multiple virtual tools associated with two-handed use.

17. A computing system for operating an artificial reality (XR) system in single-handed mode, the computing system comprising:
one or more processors; and
one or more memories storing instructions that, when executed by the one or more processors, cause the computing system to perform a process comprising:
receiving single-handed user input that comprises detected movement from a single hand of the user or input from a single hand-held controller;
translating, in response to the XR system operating in single-handed mode, the single-handed user input into two-handed input by one or more of:
simulating additional input corresponding to the single-handed user input;
predicting, using a trained machine learning model, the two-handed input based on the single-handed user input;
combining the single-handed user input and a second user input provided in a mode other than a hand gesture; or
mapping a first portion of the single-handed user input to a first hand input and mapping a second portion of the single-handed user input to a second hand input; and
causing application functionality triggered by the translated two-handed input.

18. The computing system of claim 17, wherein,
the single-handed user input is translated by simulating additional input, and
simulating additional input comprises mirroring the single-handed user input to simulate input from a second hand or second hand-held controller.

19. The computing system of claim 17, wherein,
the single-handed user input is translated by combining the single-handed user input and a second user input provided in a mode other than a hand gesture,
the single-handed user input comprises detected movement from the single hand of the user or the input from the single hand-held controller, and
the second user input comprises voice input from the user.

20. The computing system of claim 17, wherein,
the single-handed user input is translated by mapping a first portion of the single-handed user input to a first hand input and mapping a second portion of the single-handed user input to a second hand input,
the first portion comprises the detected movement from the single hand of the user or the input from the single hand-held controller at a first time,
the second portion comprises detected movement from the single hand of the user or the input from the single hand-held controller at a second time,
the second portion simulates input from a second hand or second hand-held controller, and
a signal comprised by the single-handed user input indicates a transition between the first portion and the second portion.
